(19) United States
(12) Patent Application Publication
(10) Pub. No.: US 2015/0329031 A1
(43) Pub. Date: Nov. 19, 2015

(54) SEAT-BLANKET FOR COMFORT AND PROTECTION

(71) Applicant: Yale Speegle Scott, Beverly Hills, CA (US)

(72) Inventor: Yale Speegle Scott, Beverly Hills, CA (US)

(21) Appl. No.: 14/569,629

(22) Filed: Dec. 13, 2014

Related U.S. Application Data
(60) Provisional application No. 61/993,645, filed on May 15, 2014.

(51) Int. Cl. B60N 2/60; B60N 2/44; B60N 2/48

(52) U.S. Cl. CPC B60N 2/60; B60N 2/4879; B60N 2/4415

(57) ABSTRACT

A seat-blanket for comfort and protection can include: an upper area for securing the seat-blanket to a seat for shielding an individual from direct contact with the seat.

### CROSS-REFERENCE TO RELATED APPLICATIONS

This application claims priority from U.S. Provisional Application No. 61/993,645, filed on 15 May 2014, entitled “IMPROVED AIRLINE SEAT BLANKET”, and by Yale Scott. Application No. 61/993,645 is incorporated by reference herein, in its entirety, for all purposes.

### BACKGROUND

Passengers and event-goers can employ blankets for personal comfort while traveling or attending events. For example, an airline passenger may employ a blanket for warmth. In addition, a blanket may protect an airline passenger against an unsanitary airplane seat. A blanket can also shield an airline passenger from contact with adjacent passengers under cramped conditions.

### SUMMARY

In general, in one aspect, the invention relates to a seat-blanket. The seat-blanket can include: an upper area for securing the seat-blanket to a seat, and further include a lower area for shielding an individual from direct contact with the seat.

In general, in one aspect, the invention relates to a method for making a seat-blanket. The method can include forming an upper area for securing the seat-blanket to a seat, and further include forming a lower area for shielding an individual from direct contact with the seat.

Other aspects of the invention will be apparent from the following description and the appended claims.

Embodiments of the present invention are illustrated by way of example, and not by way of limitation, in the figures of the accompanying drawings and in which like reference numerals refer to similar elements.

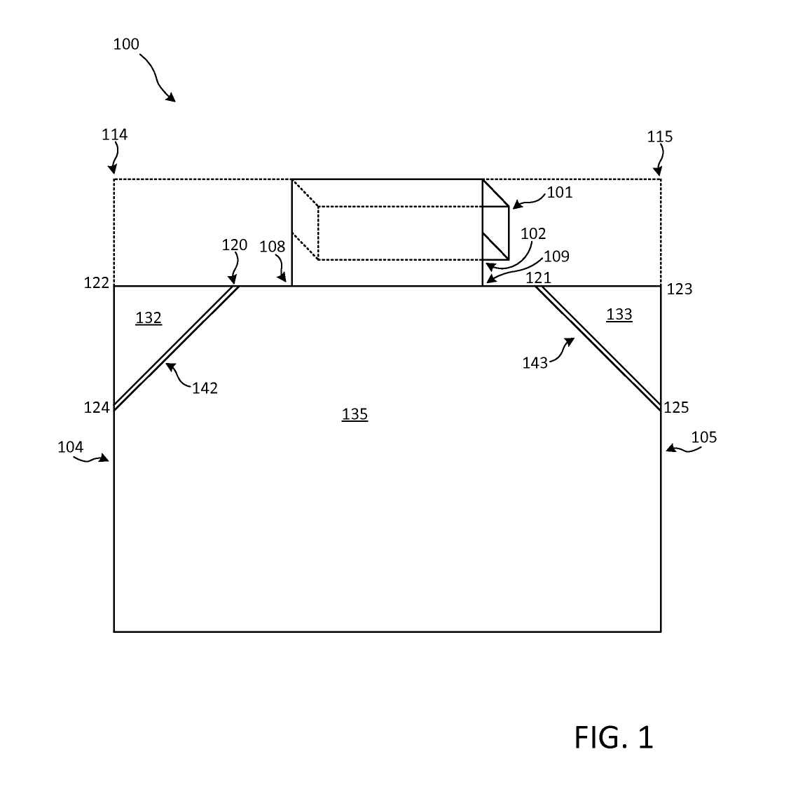

FIG. 1 illustrates a seat-blanket in one or more embodiments including an upper area for securing the seat-blanket to a seat and a lower area for protecting an individual in the seat.

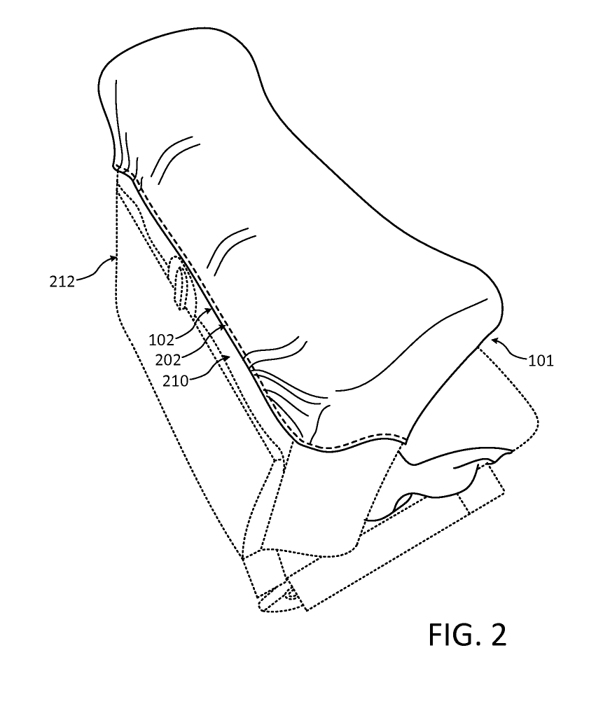

FIG. 2 is a perspective view of a seat-blanket in one or more embodiments placed securely onto a headrest of a seat.

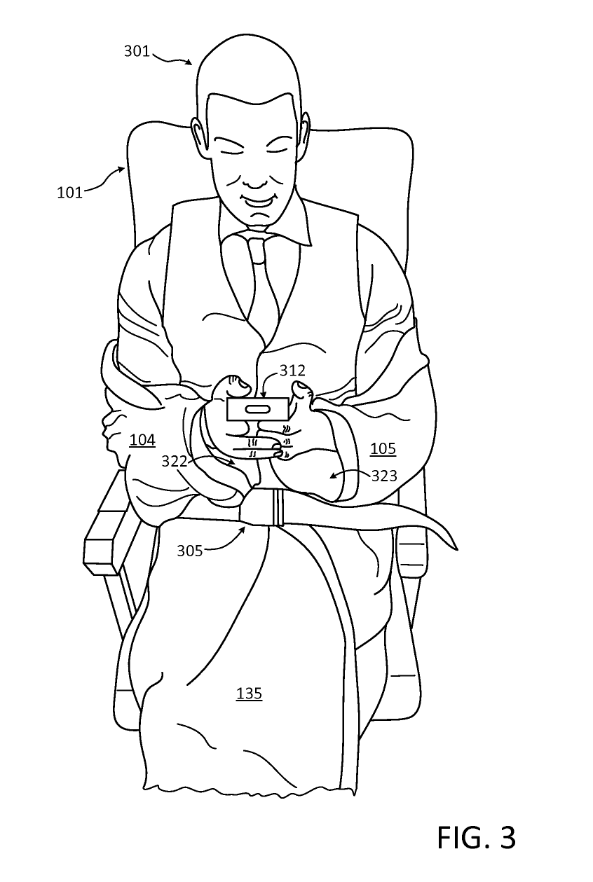

FIG. 3 shows an individual using a seat-blanket for protection and comfort in one or more embodiments.

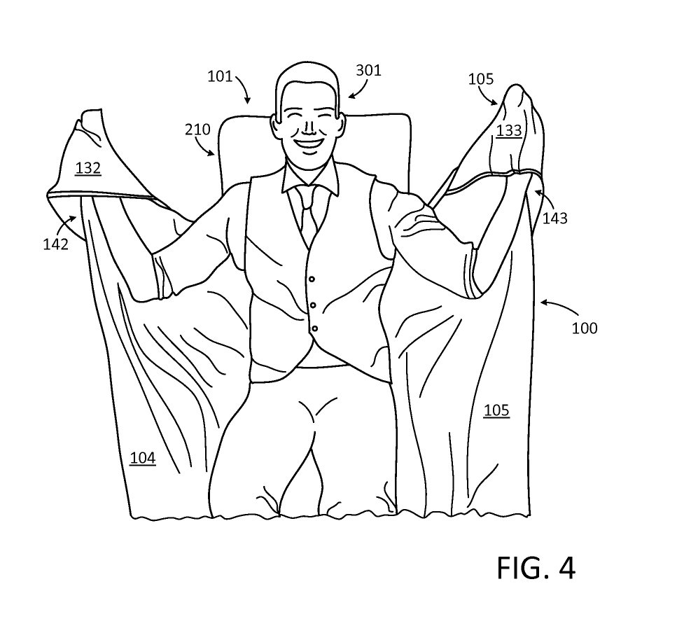

FIG. 4 shows an individual using a pair of pockets of a seat-blanket in one or more embodiments to position the seat-blanket and to independently manipulate the positions of a pair of wings of the seat-blanket.

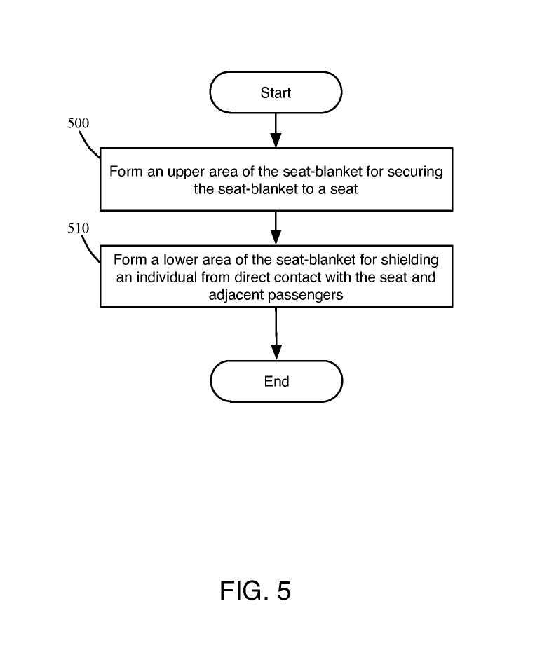

FIGS. 5 is a flowchart of a method for making a seat-blanket in accordance with one or more embodiments.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details.

FIG. 1 illustrates a seat-blanket 100 in one or more embodiments. The seat-blanket 100 includes an upper area 101 that provides a headpiece for securing the seat-blanket 100 to a seat, e.g., a passenger seat of an airliner. The seat-blanket 100 further includes a lower area 135 for shielding an individual, e.g. a passenger of an airliner, from direct contact with their seat or adjacent seats or passengers in adjacent seats.

In one or more embodiments, the upper area 101 is narrower from a point 108 to a point 109 than the lower area 135 from a point 122 to a point 123. The width of the upper area 101 can be selected for fitting the upper area 101 onto a headrest of a seat, e.g., a passenger seat of an airliner. The width of the lower area 135 can be selected to enclose fully an individual when seated in the passenger seat. Fitting onto a headrest can leave other portions of a seat accessible, e.g. for use as a flotation device.

In one or more embodiments, the upper area 101 has a shape selected for fitting securely on a seat, e.g., onto a headrest of a passenger seat of an airliner. A secure fit of the upper area 101 can prevent the seat-blanket 100 from sliding down a seat. The shape of the upper area 101 for fitting onto a headrest can be a box-shape or other shape suitable for securing to a headrest.

In one or more embodiments, the lower area 135 includes a pair of structures 132 and 133 that enable an individual to manipulate the seat-blanket 100 using their hands. The structures 132 and 133 can be attached to the seat-blanket 100 by gluing, sewing, etc. The structure 132 can be formed by attaching a triangular piece of fabric between points 120 and 122 and between points 122 and 124. Similarly, the structure 133 can be formed by attaching a triangular piece of fabric between points 121 and 123 and between points 123 and 125.

In one or more embodiments, the structures 132 and 133 can enable an individual to wrap themselves in a wing 104 and a wing 105 of the seat-blanket 100 by inserting their hands into a pair of respective openings 142 and 143 of the structures 132 and 133, and independently moving each wing 104 and 105 by applying movement to the structures 132 and 133. The structures 132 and 133 can enable an individual to cover themselves in the seat-blanket 100, thereby avoiding exposure of their hands and body while also avoiding interference with adjacent passengers. With their hands inside the structures 132 and 133, an individual can adjust the seat-blanket 100 for comfort and warmth without extending their arms and hands in a manner that would disturb adjacent passengers.

In one or more embodiments, the openings 142 and 143 of the structures 132 and 133 form pockets. In some embodiments, each structure 132 and 133 can include a second opening forming a sleeve that enables an individual to slip their hands through the structures 132 and 133 and leave their hands free while holding the wings 104 and 105 securely. The second openings can enable an individual to use an electronic device, read a book, etc., with their hands free. In some embodiments, pockets, slots, etc., may be integrated into the seat-blanket 100 for holding electronic devices.

The different widths between the points 108 and 109 and the points 122 and 123 define a pair of notched areas cut from the seat-blanket 100 as defined by dashed lines 114 and 115. The removal of material from the notched areas 114 and 115 can prevent excess material from bunching up, or hanging down and interfering with a seated individual, or interfering with individuals in adjacent seats.

FIG. 2 is a perspective view of the seat-blanket 100 placed securely onto a headrest 210 of a seat 212. The seat 212 can be a passenger seat of an airliner. In one or more embodiments, the upper area 101 includes a hem 102. The hem 102 can incorporate an elastic band 202 and a set of pleats for securing the upper area 101 to the headrest 210. Tension created by elongation of the elastic band 202 can hold the upper area 101 in place on the headrest 210. In some embodiments, the upper area 101 may include ties or other means for securing to the headrest 210.

FIG. 3 shows an individual 301 using the seat-blanket 100 for protection and comfort in one or more embodiments in which the structures 132 and 133 form a pair of sleeves 322 and 323. The sleeves 322 and 323 enable the individual 301 to use a handheld device 312. The sleeves 322 and 323 enable the individual 301 to wrap the wings 104 and 105 of the seat-blanket 100 around themselves for warmth and comfort and protection. A seatbelt 305 is buckled over the seat blanket 100.

FIG. 4 shows the individual 301 using the seat-blanket 100 for comfort and protection in embodiments in which the structures 132 and 133 form a pair of pockets. The pockets enable the individual 301 independently manipulate the positions of each wing 104 and 105 of the seat-blanket 100 by placing their respective hands in the openings 142 and 143. With the upper area 101 placed over the headrest 210, the individual 301 can place their right hand in the pocket formed by the structure 132 and their left hand in the pocket formed by the structure 133 and then wrap themselves by moving the pockets independently without disturbing or coming into contact with adjacent passengers.

The upper area 101 and the lower area 135 of the seat-blanket 100 may be formed of a single fabric. The upper area 101 and the lower area 135 can be separate fabrics that are permanently affixed, e.g., by sewing, adhering, etc.

The seat-blanket 100 can be constructed from a durable cloth, e.g., a polyester blend that provides warmth and comfort to an individual. The seat-blanket 100 can be constructed of a hypoallergenic material. The seat-blanket 100 can be constructed of an anti-microbial material. The seat-blanket 100 can be constructed of a flame retardant material. The seat-blanket 100 can be constructed of pliant and foldable fabric that provides warmth to an individual. The seat-blanket 100 can be constructed of a lightweight material that enables use of a seat belt.

The seat-blanket 100 can provide an airline passenger with comfort and protection in a cramped environment, e.g. “coach” or “economy” class. The seat-blanket 100 can shield an airline passenger from direct exposure to potentially unsanitary airplane seats which can be used by large numbers of individuals relatively frequently and which may undergo relatively infrequent cleaning The lower area 135 of the seat-blanket 100 can be cut to a size to cover a seat so that no part of an individual comes into contact with the seat.

The seat-blanket 100 can be used to provide comfort and protection on busses, trains, in movie or other theaters, stadiums, public areas, or any venue in which an individual can benefit from a securable blanket in a seated position for short-term or long-term use. The seat-blanket 100 can be used in venues having seats without a headrest.

The seat-blanket 100 can be fabric cut, hemmed, and sized to fit an average adult. The upper area 101 can be sized to fit a standard size airline seat of standard construction. Although substantially right angles are depicted in FIG. 1, the cuts at the points 122, 123, 108, and 109 can be curved, rounded, or decorative.

In one or more embodiments, the upper area 101 can include an inflatable insert for cushioning the head of an individual when seated.

FIG. 5 is a flowchart of a method for making a seat-blanket in accordance with one or more embodiments. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 5 should not be construed as limiting the scope of the invention.

In STEP 500, an upper area is formed for securing the seat-blanket to a seat. In STEP 510, a lower area is formed for shielding an individual from direct contact with the seat and adjacent passengers. The upper and lower areas can be cut to shape from one sheet of material or cut separately and then attached to one another. The upper area can be formed so that it is narrower than the lower area.

Step 500 can include forming a shape selected for fitting onto a headrest. Forming a shape for fitting onto a headrest can include integrating an elastic band into the upper area. Forming a shape for fitting onto a headrest can include forming pleats on the upper area.

Step 510 can include forming an area sized for enclosing an individual seated in a seat. The area can be based on a size of a typical individual.

Step 510 can include forming a pair of structures that enable an individual to manipulate the lower area using each respective hand of the individual. Step 510 can include forming a pair of triangles of fabric and attaching the triangles to respective wings of the lower area. Step 510 can include positioning the triangles to enable an individual to adjust a position of the seat-blanket. Step 510 can include positioning the triangles to enable an individual to adjust a position of each respective wing of the seat-blanket independently. Step 510 can include forming a pair of sleeves on the lower area.

While the invention has been described with respect to a limited number of embodiments, those skilled in the art, having benefit of this disclosure, will appreciate that other embodiments may be devised which do not depart from the scope of the invention as disclosed herein.

What is claimed is:

1. A seat-blanket, comprising:
an upper area for securing the seat-blanket to a seat; and
a lower area for shielding an individual from direct contact with the seat.

2. The seat-blanket of claim 1, wherein the upper area is narrower than the lower area.

3. The seat-blanket of claim 1, wherein the upper area has a shape selected for fitting securely on the seat.

4. The seat-blanket of claim 1, wherein the upper area has a shape selected for fitting onto a headrest.

5. The seat-blanket of claim 1, wherein the upper area includes a hem incorporating an elastic band and pleats for securing to a headrest.

6. The seat-blanket of claim 1, wherein the upper area includes an inflatable insert for cushioning a head of the individual.

7. The seat-blanket of claim 1, wherein the lower area is sized for enclosing the individual seated in the seat.

8. The seat-blanket of claim 1, wherein the lower area comprises a pair of structures that enable the individual to manipulate the seat-blanket using each respective hand of the individual.

9. The seat-blanket of claim 8, wherein the structures are positioned to enable the individual to adjust a position of the seat-blanket.

10. The seat-blanket of claim 8, wherein the structures are positioned to enable the individual to wrap the seat-blanket around the individual.

11. The seat-blanket of claim 8, wherein the structures comprise a pair of pockets.

12. The seat-blanket of claim 1, wherein the lower area comprises a pair of structures each having a first opening for accepting a respective hand of the individual and a second opening providing a sleeve for a respective hand and arm of the individual.

13. A method for making a seat-blanket, comprising:
forming an upper area for securing the seat-blanket to a seat; and
forming a lower area for shielding an individual from direct contact with the seat.

14. The method of claim 13, wherein the steps of forming comprise forming the upper area and the lower area such that the upper area is narrower than the lower area.

15. The method of claim 13, wherein forming an upper area comprises forming a shape selected for fitting securely on the seat.

16. The method of claim 13, wherein forming an upper area comprises forming a shape selected for fitting onto a headrest.

17. The method of claim 13, wherein forming a lower area comprises forming an area sized for enclosing the individual seated in the seat.

18. The method of claim 13, wherein forming a lower area comprises forming a pair of structures that enable the individual to manipulate the seat-blanket using each respective hand of the individual.

19. The method of claim 18, wherein forming a pair of structures comprises forming a pair of structures positioned to enable the individual to adjust a position of the seat-blanket.
